(19) United States
(12) Patent Application Publication
(10) Pub. No.: US 2024/0150037 A1
(43) Pub. Date: May 9, 2024

(54) AEROELASTIC ADJUSTMENT USING FLUTTER VECTOR STRAIN ENERGY

(71) Applicant: THE BOEING COMPANY, Chicago, IL (US)

(72) Inventor: Darin Haudrich, St. Louis, MO (US)

(21) Appl. No.: 18/053,425

(22) Filed: Nov. 8, 2022

(51) Int. Cl. B64F 5/00; B64C 21/02; G06F 30/23

(52) U.S. Cl. CPC B64F 5/00; B64C 21/02; G06F 30/23

(57) ABSTRACT

A method includes determining, based on flutter data and modal strain energy data, a flutter strain energy distribution of a modeled structure. The method includes identifying, based on the flutter strain energy distribution, regions of the modeled structure that are determined to have a flutter vector strain energy above a threshold. The method includes updating a model to increase a mass, a stiffness, or both, of one or more of the regions to improve a flutter characteristic of the modeled structure. The method further includes providing indicia including instructions for manufacture or modification of the modeled structure to achieve the improved flutter characteristic.

### FIELD OF THE DISCLOSURE

The present disclosure is generally related to improving a flutter characteristic of a modeled structure.

### BACKGROUND

Flutter is an aeroelastic instability in which oscillatory vibration diverges. Flutter analysis is typically computed in the frequency domain and the instability is a result of modal coupling. Flutter is a dynamic instability that involves the interaction of the elastic, inertial, and unsteady aerodynamic forces. Because the airspeed at which an aerodynamic component of an aircraft experiences divergent oscillatory vibration, referred to herein as flutter speed, can impose an upper limit on the speed of the aircraft, aircraft performance can be improved by designing such components to have higher flutter speed.

Changing the flutter speed of a component typically involves changing the elastic, inertial, or unsteady aerodynamics of the component. This is most routinely performed by changing the stiffness or mass properties, or both, through an adjoint or sensitivity of the full mass or stiffness matrices associated with a model (e.g., a finite element model) of the component. Guidance for structural sizing is typically provided by the modal characteristics of the component, including frequency and modeshape, and thus the strain energy. Modal strain energy has been used to identify areas/elements for model correlation as well as for aeroelastic sizing. An improved technique for adjusting such components to achieve higher flutter speed, or to satisfy a speed criterion using less mass and/or stiffness, as compared to conventional techniques would enable improvements in aircraft performance, weight, and cost of manufacture.

### SUMMARY

In a particular implementation, a method includes determining, based on flutter data and modal strain energy data, a flutter strain energy distribution of a modeled structure. The method includes identifying, based on the flutter strain energy distribution, regions of the modeled structure that are determined to have a flutter vector strain energy above a threshold. The method includes updating a model to increase a mass, a stiffness, or both, of one or more of the regions to improve a flutter characteristic of the modeled structure. The method further includes providing indicia including instructions for manufacture or modification of the modeled structure to achieve the improved flutter characteristic.

In another particular implementation, an aircraft includes a cantilevered structure having a root portion, a tip portion, a leading edge portion, and a trailing edge portion. The aircraft also includes at least one flight surface that includes a surface of the cantilevered structure. A region of the cantilevered structure that is located at substantially a midpoint between the root portion and the tip portion has an increased mass as compared to one or more neighboring regions of the cantilevered structure. The region is selected to have the increased mass to increase a flutter speed based on a flutter strain energy distribution generated from a model of the cantilevered structure.

In another particular implementation, a non-transitory computer-readable medium stores instructions that, when executed by one or more processors, cause the one or more processors to determine, based on flutter data and modal strain energy data, a flutter strain energy distribution of a modeled structure. The instructions, when executed by the one or more processors, also cause the one or more processors to identify, based on the flutter strain energy distribution, regions of the modeled structure that are determined to have a flutter vector strain energy above a threshold. The instructions, when executed by the one or more processors, further cause the one or more processors to update a model to increase a mass, a stiffness, or both, of one or more of the regions to improve a flutter characteristic of the modeled structure. The instructions, when executed by the one or more processors, also cause the one or more processors to provide indicia including instructions for manufacture or modification of the modeled structure to achieve the improved flutter characteristic.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system configured to perform aeroelastic adjustment based on flutter vector strain energy.

FIG. 2 is a diagram of a particular implementation of operations performed by the system of FIG. 1.

FIG. 3A is a diagram that illustrates a first example of flutter characteristics used by the system of FIG. 1.

FIG. 3B is a diagram that illustrates a second example of flutter characteristics used by the system of FIG. 1.

FIG. 4A is a diagram that illustrates a first example of modal characteristics used by the system of FIG. 1.

FIG. 4B is a diagram that illustrates a second example of modal characteristics used by the system of FIG. 1.

FIG. 5 is a diagram that illustrates a third example of flutter characteristics used by the system of FIG. 1.

FIG. 6 is a diagram that illustrates an example of a flutter strain energy distribution used by the system of FIG. 1.

FIG. 7 is a diagram that illustrates an example of a flutter strain energy distribution after aeroelastic adjustment by the system of FIG. 1.

FIG. 8 is a diagram that illustrates an example of an aircraft including structures designed based on aeroelastic adjustment performed by the system of FIG. 1.

FIG. 9 is a diagram that illustrates examples of a cantilevered structure designed based on aeroelastic adjustment performed by the system of FIG. 1.

FIG. 10 is a diagram that illustrates an example of a relationship between torsion mode contribution to a flutter vector and flutter speed.

FIG. 11 is a flowchart illustrating a method of performing aeroelastic adjustment based on flutter vector strain energy.

FIG. 12 is a block diagram of a computing environment including a computing device configured to support aspects of computer-implemented methods and computer-executable program instructions (or code) according to the present disclosure.

### DETAILED DESCRIPTION

Aspects disclosed herein present systems and methods for aeroelastic adjustment based on flutter vector strain energy. Conventional techniques, such as using modal strain energy based on finite element modeling to identify areas of a structure for aeroelastic modification, fail to account for flutter and thus can provide results that are incomplete and/or have reduced accuracy. By using flutter vector strain energy to identify areas for modification, the disclosed systems and methods can identify solutions that conventional techniques fail to identify and can therefore provide more complete and accurate results. Thus, the disclosed systems and methods enable more efficient and/or more effective aeroelastic modification, resulting in improved performance of an aircraft or other apparatus that incorporates such modified structures.

According to an aspect, the complex flutter vector strain energy for a structure is determined using the combination of the modal strain energy of the structure, such as determined via a finite element model, with the flutter vector as determined via an aerodynamic model. Areas of the structure exhibiting high flutter vector strain energy are identified as candidates for modification, such as by increasing mass, stiffness, or both, in one or more of the identified areas.

According to some aspects, a cantilevered structure such as an aircraft wing or stabilizer, can exhibit high flutter vector strain energy at one or more areas that are not identified by conventional techniques, such as areas located at a leading edge and a trailing edge of the structure at a mid-point between the structure's root and tip. Increases in mass and stiffness at these identified areas can result in improved flutter characteristics (e.g., increased flutter speed), and in some cases these improvements in flutter characteristics are shown to be comparable to, or better than, improvements resulting from aeroelastic modifications guided by conventional techniques.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

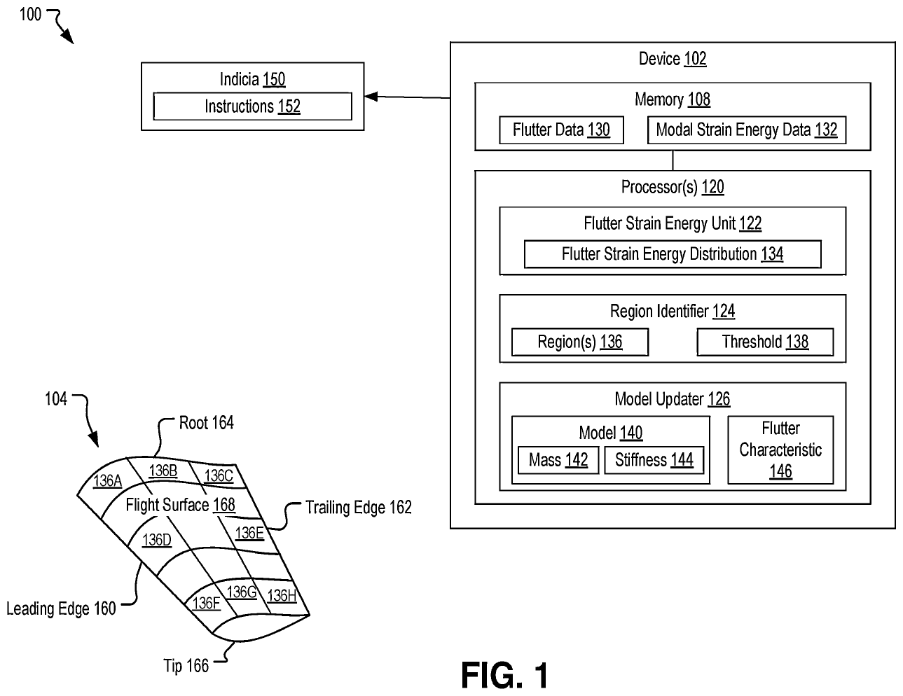

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple regions are illustrated and associated with reference numbers 136A, 136B, 136C, etc. When referring to a particular one of these regions, such as the region 136A, the distinguishing letter “A” is used. However, when referring to any arbitrary one of these regions or to these regions as a group, the reference number 136 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 120 in FIG. 1), which indicates that in some implementations the device 102 includes a single processor 120 and in other implementations the device 102 includes multiple processors 120. For ease of reference herein, such features are generally introduced as “one or more” features, and are subsequently referred to in the singular unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

Referring to FIG. 1, a system 100 illustrates an implementation of a device 102 that is operable to determine an aeroelastic adjustment for a modeled structure 104 based on flutter vector strain energy.

The modeled structure 104 includes a flight surface 168 of an aircraft. To illustrate, the modeled structure 104 can include a portion (or all) of a wing, a horizontal stabilizer, or a vertical stabilizer, as illustrative, non-limiting examples. The modeled structure 104 corresponds to a cantilevered structure having a root portion 164 (e.g., where the modeled structure 104 is attached to a fuselage of the aircraft), a tip portion 166, a leading edge portion 160 (e.g., oriented toward the direction of forward motion of the aircraft), and a trailing edge portion 162.

As illustrated, the modeled structure 104 is logically partitioned into multiple regions, including representative regions 136A, 136B, and 136C along the root portion 164, representative regions 136D and 136E at the leading edge portion 160 and the trailing edge portion 162, respectively, that are located approximately mid-way between the leading edge portion 160 and the trailing edge portion 162, and representative regions 136F, 136G, and 136H along the tip portion 166. Although the regions 136 are illustrated as arranged in a substantially regular square grid pattern, in other implementations the regions 136 may have one or more different shapes or sizes, may be arranged in a different grid pattern (e.g., a regular or irregular triangular grid), or any combination thereof.

The device 102 is configured to generate and update one or more models of the modeled structure 104 to improve a flutter characteristic 146 of the modeled structure 104. The device 102 includes one or more processors 120 coupled to a memory 108. The one or more processors 120 can be implemented as a single processor or as multiple processors, such as in a multi-core configuration, a multi-processor configuration, a distributed computing configuration, a cloud computing configuration, or any combination thereof.

According to an aspect, the memory 108 is configured to store data associated with aeroelastic adjustment of the modeled structure 104, illustrated as flutter data 130 and modal strain energy data 132. According to an aspect, the flutter data 130 indicates displacement in the modeled structure 104 based on an aerodynamic model, and the modal strain energy data 132 indicates strain energy in the modeled structure 104 for one or more bending modes, one or more torsion modes, or a combination thereof. In an illustrative example, the modal strain energy data 132 is determined based on a finite element model. The flutter data 130, the modal strain energy data 132, or both, can be generated at the device 102, provided to the device 102 from one or more remote devices or systems, or a combination thereof.

The one or more processors 120 include a flutter strain energy unit 122, a region identifier 124, and a model updater 126. In some implementations, one or more portions of the flutter strain energy unit 122, the region identifier 124, the model updater 126, or a combination thereof, are implemented by the one or more processors 120 using dedicated hardware, firmware, or a combination thereof. In some implementations, one or more portions of the flutter strain energy unit 122, the region identifier 124, the model updater 126, or a combination thereof, can be implemented at least in part by the one or more processors 120 executing instructions.

The flutter strain energy unit 122 is configured to compute a flutter strain energy distribution 134 based on the flutter data 130 and the modal strain energy data 132, as described further below.

The region identifier 124 is configured to identify, based on the flutter strain energy distribution 134, particular regions 136 of the modeled structure 104 that are determined to have a flutter vector strain energy above a threshold 138. In some implementations, the flutter strain energy distribution 134 includes data indicating, for each of a set of points or locations of the modeled structure 104, an estimated value of flutter strain energy at that point or location. According to some aspects, the region identifier 124 processes the flutter strain energy distribution 134 to identify values of the flutter strain energy that exceed the threshold 138 and generates a list of the regions 136 that are associated with flutter strain energy exceeding the threshold 138.

The model updater 126 is configured to update a model 140 of the modeled structure 104 to increase a mass 142, a stiffness 144, or both, of one or more of the regions 136 having flutter vector strain energy above the threshold 138 to improve a flutter characteristic 146 of the modeled structure 104. To illustrate, the increased mass 142, stiffness 144, or both, can represent a change in material used in the modeled structure 104, an increased amount of material used in the modeled structure 104, a change in internal structural rigidity components (e.g., via honeycombing) of the modeled structure 104, or a combination thereof, as illustrative, non-limiting examples.

In an example, the flutter characteristic 146 corresponds to a flutter speed. In this example, the model updater 126 increasing the mass 142, the stiffness 144, or both, of one or more particular regions to reduce the flutter vector strain energy associated with the particular regions results in an increase of the flutter speed. According to an aspect, the one or more particular regions are adjusted so that, after updating the model 140, the flutter vector strain energy of the one or more particular regions is below the threshold 138.

The device 102 is configured to generate indicia 150 including instructions 152 for manufacture or modification of the modeled structure 104 to achieve the improved flutter characteristic 146. For example, the device 102 can transmit the indicia 150 to a user interface device or a storage device via one or more wired connections or networks, one or more wireless connections or networks, or a combination thereof. To illustrate, the device 102 can transmit the indicia 150 to a display device that is coupled to, or integrated with, the device 102 for display of the instructions 152 to a manufacturing engineer or technician. The instructions 152 can indicate an amount of mass to add to the modeled structure 104, one or more locations where the mass is to be added to the modeled structure 104, how and where to increase a stiffness of the modeled structure 104, etc. In another example, the indicia 150 including the instructions 152 have a machine-readable format and are provided to automated manufacturing equipment for fabrication of the modeled structure 104 having the updated characteristics.

By performing aeroelastic adjustment of the modeled structure 104 to reduce the flutter characteristic 146, performance of an aircraft that incorporates the modeled structure 104 can be improved. In an example in which the flutter speed imposes an upper safe limit on aircraft speed, increasing the flutter speed increases the upper safe limit and allows the aircraft to travel at higher speed. In another example, adjusting the model 140 to reduce flutter vector strain energy in one or more portions of the modeled structure 104 can enable mass or stiffness characteristics at one or more other portions of the modeled structure 104 to be reduced without negatively impacting the flutter characteristic 146, resulting in improved aircraft performance due to reduced weight, reduced cost of materials, or both.

Although the techniques described herein are illustrated using examples involving aircraft, it should be understood that the described techniques are not limited to aircraft and may be applied to any structure, vehicle, or device that is susceptible to flutter arising from fluid flow (e.g., air or other gases, water or other liquids, etc.) across the structure.

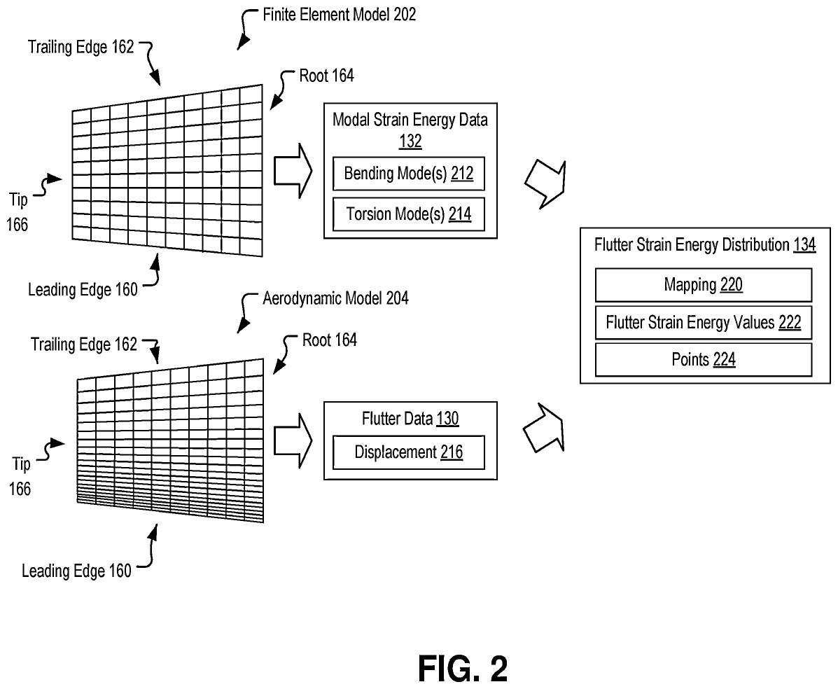

Illustrative examples in which the modeled structure 104 corresponds to a 0.25 inch thick aluminum plate that is cantilevered at the root portion 164 and that weighs approximately 63 lbs. (referred to as a “plate model”) are described with reference to FIGS. 2-7.

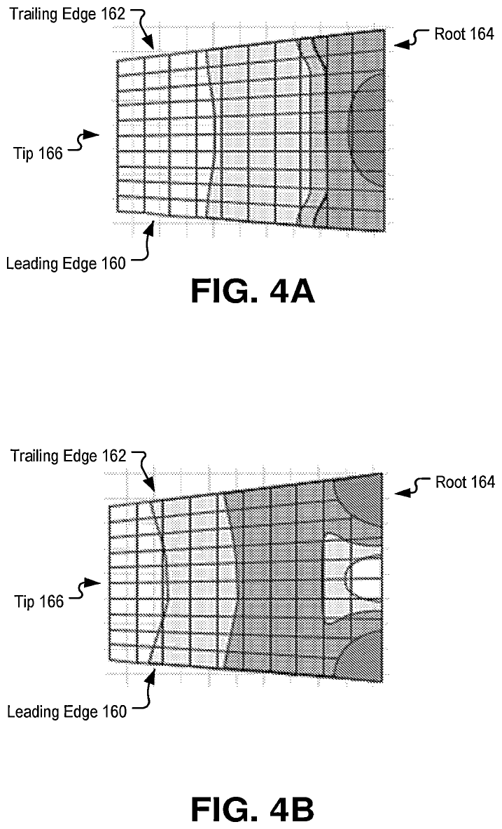

In FIG. 2, operations associated with analysis of the plate model are illustrated. A finite element model 202 of the modeled structure 104 is used to perform finite element analysis to determine the modal strain energy data 132. As illustrated, the finite element model 202 includes 100 elements arranged as a regular rectangular grid, and the plate model exhibits a baseline bending frequency of 2.45 Hz and torsion mode frequency of 8.34 Hz. The modal strain energy data 132 includes data indicating strain energy associated with one or more bending modes 212 and one or more torsion modes 214 of the modeled structure 104, as described further with reference to FIG. 4A and FIG. 4B.

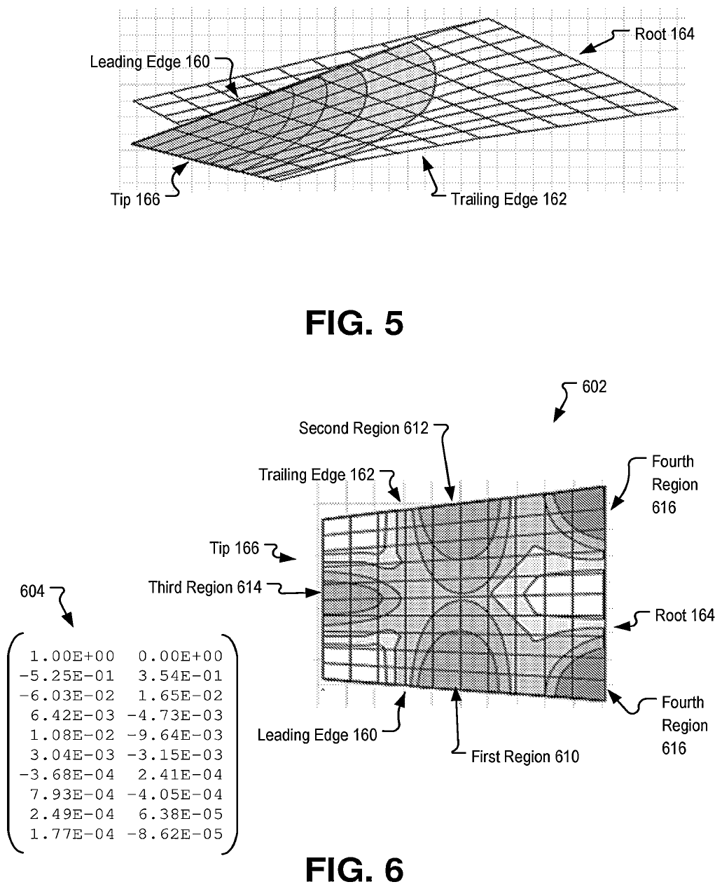

An aerodynamic model 204 of the modeled structure 104 is used to perform aerodynamic analysis of the modeled structure 104 to generate the flutter data 130. As illustrated, the aerodynamic model 204 is a doublet lattice model that has 20 chordwise boxes and 10 spanwise boxes. The flutter data 130 includes a flutter vector that indicates displacement 216 of portions of the modeled structure 104, as described further with reference to FIG. 5.

The modal strain energy data 132 of the finite element model 202 and the flutter data 130 of the aerodynamic model 204 are used in combination to generate the flutter strain energy distribution 134, as described further with reference to FIG. 6. The flutter strain energy distribution 134 includes a mapping 220 of flutter strain energy values 222 to points 224 (e.g., grid elements) of the modeled structure 104.

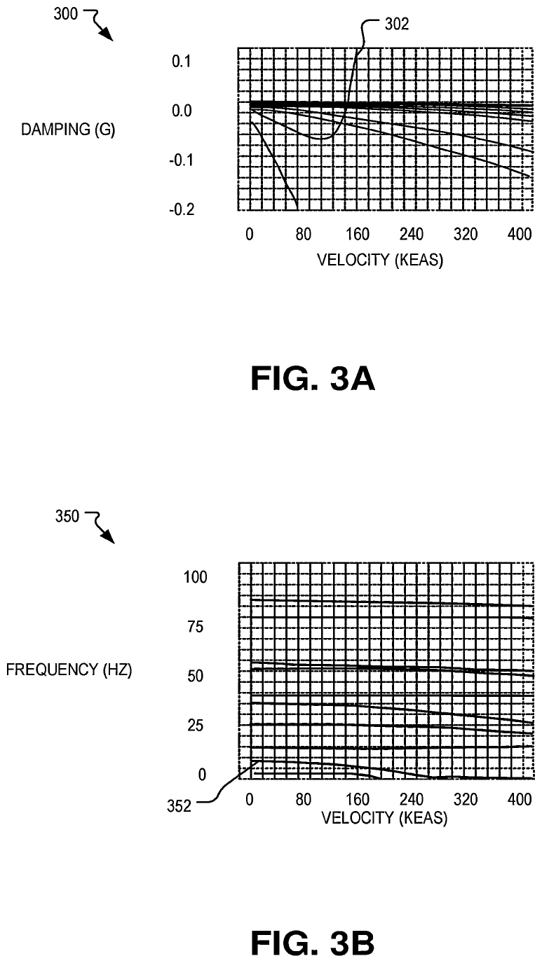

FIGS. 3A and 3B illustrate baseline velocity (v), damping (g), and frequency (f) (v-g-f) characteristics associated with the plate model and determined via baseline flutter analysis. FIG. 3A illustrates a graph 300 showing damping as a function of velocity (in units of knots equivalent air speed (KEAS)), and FIG. 3B illustrates a graph 350 showing frequency (in Hertz (Hz)) as a function of velocity, for 10 modes (e.g., the bending modes 212 and the torsion modes 214). As illustrated in the graph 300, a curve 302 associated with Root 2 exhibits a steep flutter crossing, transitioning from having a negative damping value to a positive damping value at 152 KEAS. The flutter crossing is associated with a flutter frequency of 5.4 Hz, as shown by a value of a corresponding curve 352 of the graph 350. The flutter crossing associated with the curve 302 is primarily a coupling of the first bending mode and the first torsion mode. Additional flutter crossings (not illustrated) occur at 464 KEAS and 600 KEAS.

FIG. 4A illustrates the modal strain energy for the first bending mode, and FIG. 4B illustrates the modal strain energy for the first torsion mode of the cantilevered plate. In FIGS. 4A and 4B, lighter shades represent lower strain energy values, and darker shades represent higher strain energy values. The strain energy values have been normalized for comparison purposes. Both FIG. 4A and FIG. 4B show that the largest strain energy occurs at the root portion 164, representing a fixed end of the cantilevered plate. The largest bending mode strain energy is located at the center of the root portion 164, while the largest torsion mode strain energy is at the leading edge and trailing edge of the root portion 164. Based on this information, to change the modal characteristics of either the first bending mode or the first torsion mode, modifications of the elements with largest strain energy would have the largest impact. Since these are the two modes that contribute to the flutter crossing, conventional aeroelastic tailoring would focus on trying to increase first torsion frequency by increasing stiffness where the modal strain energy for the torsion mode is largest.

According to the techniques presented herein, rather than basing aeroelastic tailoring on the modal strain energy, aeroelastic tailoring is instead based on complex strain energy (e.g., the flutter strain energy distribution 134) that is computed from the matrix multiplication of the flutter vector for the unstable crossing and the modal strain energy. This approach is similar to the computation that obtains the physical flutter vector for the baseline case, as shown in FIG. 5.

In FIG. 5, an example 502 of the physical flutter vector corresponding to the first flutter crossing for the plate model is depicted, in which darker shades indicate larger displacement magnitudes and lighter shades indicate smaller displacement magnitudes. As illustrated, the largest displacement occurs at the tip of the leading edge.

The physical flutter vector is defined in Equation 1:

φₐₕ=φₐuₕ (Eq. 1)

where φₐₕ represents a physical degree of freedom flutter vector, φₐ represents an analysis set degree of freedom modal vector, and u h represents a participation of flutter vector.

The computation of Equation 1 is extended for the complex flutter strain energy in Equation 2:

ESEₐₕ=ESEₐuₕ (Eq. 2)

where ESE represents elemental strain energy.

Although the complex modeshape of the flutter strain energy of Equation 2 corresponds to a combination of 10 modes, the main contributors are mode 1 and 2. Modes 3-10 are an order of magnitude less in both the real and imaginary part of the modal participation.

FIG. 6 illustrates the magnitude of the complex flutter strain energy distribution 602 (e.g., the flutter strain energy distribution 134) where lighter shades represent lower strain energy values, and darker shades represent higher strain energy values. The complex vector 604 associated with the first flutter crossing for the plate model is also illustrated.

The complex flutter strain energy distribution 602 depicts regions of high strain energy at the root portion 164, such as predicted by the modal strain energy depicted in FIGS. 4A and 4B. However, the complex flutter strain energy distribution 602 also depicts regions of high strain energy that are not predicted by the modal strain energy depicted in FIGS. 4A and 4B, such as a first region 610 at the leading edge portion 160, a second region 612 at the trailing edge portion 162, and a third region 614 at the tip portion 166.

Aeroelastic tailoring based on the complex flutter strain energy distribution 602 (e.g., the flutter strain energy distribution 134) can be analyzed by increasing stiffness, and also increasing both mass and stiffness, independently at each of the regions of high strain energy depicted in FIG. 6; in particular, at the root portion 164, at the first region 610, at the second region 612, at the third region 614, and at a fourth region 616 (e.g., at both the leading and trailing edges at the root portion 164). In an analysis in which each of these regions were modified to double the thickness of the corresponding elements (both with and without changing the mass of the elements), the largest change in flutter speed occurs as a result of modifying the elements at the first region 610 (e.g., mid-span, leading edge), exhibiting a 2.76% increase in flutter speed from an increase in stiffness only, and a 4.14% increase in flutter speed from an increase in both mass and stiffness.

As compared to modifying the first region 610, modifying the elements at the second region 612 (e.g., mid-span, trailing edge) by increasing mass and stiffness produces a smaller increase in flutter speed and flutter frequency and similar changes on weight increase, bending and torsion frequency. As compared to modifying the first region 610, modifying the elements at the third region 614 (e.g., full-span, mid-chord) by increasing mass and stiffness produces a smaller increase on flutter speed, as well as a larger impact on the bending frequency and little impact on torsion frequency.

As compared to modifying the first region 610, modifying the elements at the fourth region 616—the high-strain energy areas of the root portion 164—by increasing mass and stiffness results in a similar ratio of weight increase to flutter speed increase, and also results in larger bending and torsion frequency changes. This region is the most likely region to be updated based on conventional techniques due to the high strain energy determined via finite element modeling (e.g., as shown in FIG. 4B), but the increase in flutter speed is via a different mechanism as compared to modifying the first region 610. In particular, modifying the first region 610 decreases the flutter frequency, while modifying the fourth region 616 increases the flutter frequency since both the bending and torsion modes increase. Also, although in the first region 610 the increases in mass and stiffness together appear to drive the increase in flutter speed, in the fourth region 616 the increase in stiffness appears to be the primary driver of the increase in flutter speed, which is likely due to the cantilevered boundary condition reducing the impact of the additional mass at the root.

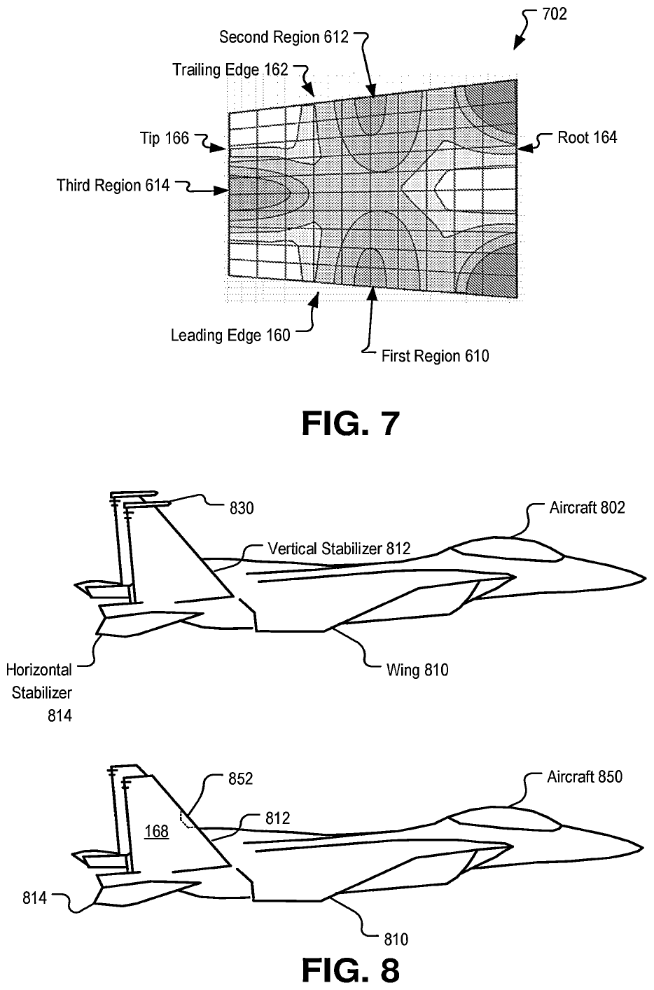

FIG. 7 is a diagram that illustrates an example of a flutter strain energy distribution 702 (e.g., the modeled flutter strain energy distribution 134) after aeroelastic adjustment of the modeled structure 104 by increasing the mass and stiffness at the first region 610. As compared to the flutter strain energy distribution 602 of FIG. 6, the flutter strain energy distribution 702 demonstrates significantly reduced strain energy at the first region 610 and the second region 612 as a result of increasing the mass and stiffness at the first region 610.

FIG. 8 depicts an example of a first aircraft 802 and a second aircraft 850 to compare aeroelastic tailoring using conventional techniques and using the present techniques. The first aircraft 802 depicts a result of aeroelastic adjustment using a conventional technique that includes adding a mass 830 at the tip of each of the vertical stabilizers 812, which increases the flutter speed by increasing the mass at the leading edge of the vertical stabilizer 812 and also improves the first torsion mode of the vertical stabilizer 812.

In contrast, the second aircraft 850 depicts a result of aeroelastic adjustment using the present techniques. The second aircraft 850 omits the mass 830 and instead includes adding a modification structure 852 (illustrated in dashed lines to indicate that the modification structure 852 may not be visible to an external observer) to add mass, stiffness, or both, to the leading edge of the vertical stabilizer 812 approximately at a midpoint between the root and the tip of the vertical stabilizer 812, corresponding to the first region 610 of FIG. 6.

Although the second aircraft 850 is depicted as including the modification structure 852 at the leading edge of a flight surface 168 of the vertical stabilizer 812, in other implementations, structures analogous to the modification structure 852 can be added at regions of one or more other cantilevered structures (e.g., a wing 810, a horizontal stabilizer 814, etc.) so that the cantilevered structures have an increased mass at substantially a midpoint between the root portion and the tip portion as compared to one or more neighboring regions of the cantilevered structure. Such modification structures 852 may be located at the leading edge portion or the trailing edge portion (e.g., corresponding to the first region 610 or the second region 612), or both, and the locations of such modification structures 852 can be selected to provide increased mass to increase a flutter speed based on a modeled flutter strain energy distribution 134 of each cantilevered structure.

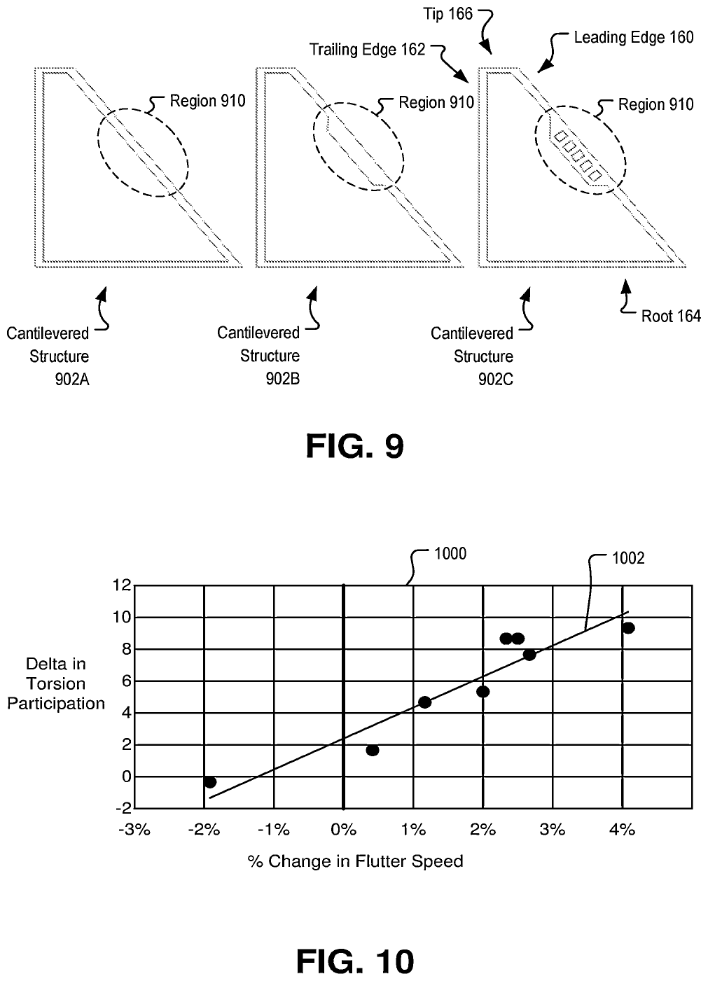

FIG. 9 is a diagram that illustrates examples of a cantilevered structure and modifications that can correspond to the modification structure 852 of the vertical stabilizer 812 of FIG. 8. In a first example, a leading edge of a cantilevered structure 902A (e.g., the vertical stabilizer 812) includes a region 910 approximately at a midpoint between the root portion 164 and the tip portion 166 and that has the same mass, density (e.g., mass per unit volume), or both as nearby regions. In a second example, a cantilevered structure 902B has an increased mass in the region 910, depicted as an increased thickness of a material of the leading edge portion 160. In a third example, a cantilevered structure 902C has the increased thickness of the leading edge portion 160 as in the second example, with additional modification illustrated as rectangular structural elements. In some implementations, the rectangular structural elements correspond to cutouts (e.g., holes in the material) to decrease mass while maintaining stiffness. In other implementations, the rectangular structural elements correspond to a different material, such as to increase (or decrease) mass via use of higher (or lower) density material.

FIG. 10 is a diagram 1000 that illustrates an example of a relationship between torsion mode contribution to a flutter vector and flutter speed. As described previously, the flutter vector is driven primarily by the first two modes (e.g., the first bending and first torsion modes). In the eight cases described in FIG. 6—increasing stiffness only in each of the regions 610, 612, 614, and 616, and increasing mass and stiffness in each of the regions 610, 612, 614, and 616—the first bending mode is the largest contributor. After normalizing the first bending mode to 1, it was observed that torsion mode participation trended and correlated well with the change in flutter speed. This trend is illustrated in the diagram 1000, where the change in the real part of the torsion participation is plotted against the percent change in flutter speed for each of the eight cases, and a trend line 1002 illustrates a best fit relationship based on the plotted points. This plot indicates that a more shared flutter shape or larger influence in wing torsion would result in an increase in flutter speed. This information, as well as the flutter strain energy, which are connected through the unstable flutter vector, provides alternative approaches for aeroelastic tailoring during structural optimization.

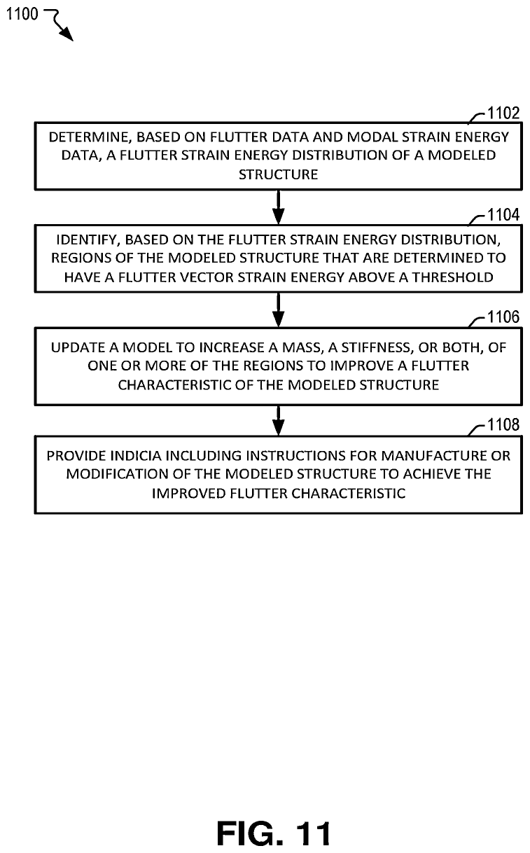

FIG. 11 is a flowchart illustrating a method 1100 of performing aeroelastic adjustment based on flutter vector strain energy. In a particular implementation, the method 1100 is performed by the one or more processors 120, the device 102, or the system 100 of FIG. 1.

The method 1100 includes, at block 1102, determining, based on flutter data and modal strain energy data, a flutter strain energy distribution of a modeled structure. For example, the flutter strain energy distribution 134 of the modeled structure 104 is determined based on the flutter data 130 and the modal strain energy data 132. According to an aspect, the flutter data indicates displacement (e.g., the displacement 216) in the modeled structure based on an aerodynamic model (e.g., the aerodynamic model 204), and the modal strain energy data indicates strain energy in the modeled structure for one or more bending modes (e.g., bending modes 212), one or more torsion modes (e.g., torsion modes 214), or a combination thereof. According to some implementations, the modal strain energy data is determined based on a finite element model, such as the finite element model 202, and the flutter data is determined based on an aerodynamic model, such as the aerodynamic model 204. In a particular example, the modeled structure includes at least one flight surface of an aircraft, such as the flight surface 168 of the aircraft 850. To illustrate, the modeled structure can correspond to at least a portion of: a wing, a horizontal stabilizer, or a vertical stabilizer.

The method 1100 includes, at block 1104, identifying, based on the flutter strain energy distribution, regions of the modeled structure that are determined to have a flutter vector strain energy above a threshold. For example, regions 136 of the modeled structure 104 are identified based on the flutter strain energy distribution 134 indicating areas where the flutter strain energy is greater than the threshold 138. In an illustrative example, the flutter strain energy distribution includes a mapping of flutter strain energy values to points of the modeled structure, such as the mapping 220 of the flutter strain energy values 222 to the points 224.

The method 1100 includes, at block 1106, updating a model to increase a mass, a stiffness, or both, of one or more of the regions to improve a flutter characteristic of the modeled structure. To illustrate, the device 102 updates the model 140 to increase the mass 142, the stiffness 144, or both, of one or more of the regions 136 to improve the flutter characteristic 146. In an example, the flutter characteristic corresponds to a flutter speed, and increasing the mass, the stiffness, or both increases the flutter speed. According to an aspect, after updating the model, the flutter vector strain energy of the one or more of the regions is below the threshold.

In some implementations, updating the model includes increasing the mass, the stiffness, or both, at a leading edge portion of the modeled structure, a trailing edge portion of the modeled structure, or both. In an illustrative example, the modeled structure corresponds to a cantilevered structure, such as the cantilevered structure 902 having the root portion 164, the tip portion 166, the leading edge portion 160, and the trailing edge portion 162, and updating the model includes increasing the mass, the stiffness, or both at a location (e.g., the region 910) that is between the root portion and the tip portion.

The method 1100 includes, at block 1108, providing indicia including instructions for manufacture or modification of the modeled structure to achieve the improved flutter characteristic. For example, the device 102 provides the indicia 150 including the instructions 152 to one or more remote devices, such as for display at a display device.

The method 1100 thus enables aeroelastic adjustment of a modeled structure to improve the flutter characteristic, resulting in improved performance of an aircraft that incorporates the modeled structure. For example, the aeroelastic adjustment can increase the flutter speed, which can increase the upper safe airspeed limit for an aircraft that incorporates the modeled structure. In another example, adjusting the model to reduce flutter vector strain energy in one or more portions of the modeled structure can enable mass or stiffness characteristics at one or more other portions of the modeled structure to be reduced without negatively impacting the flutter characteristic, resulting in reduced material cost, improved aircraft performance due to reduced weight, or both.

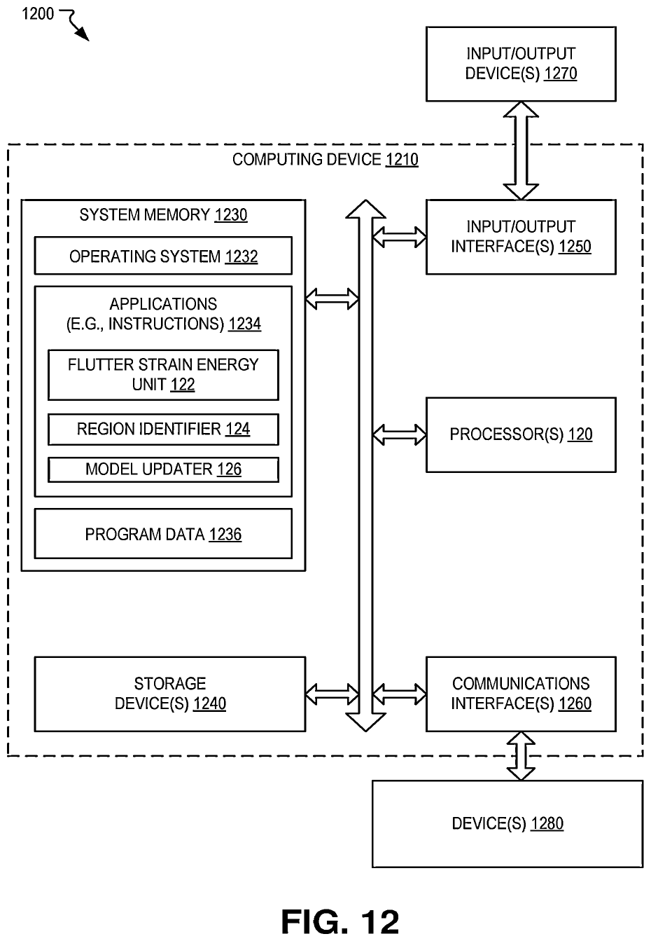

FIG. 12 is a block diagram of a computing environment 1200 including a computing device 1210 configured to support aspects of computer-implemented methods and computer-executable program instructions (or code) according to the present disclosure. For example, the computing device 1210, or portions thereof, is configured to execute instructions to initiate, perform, or control one or more operations described with reference to FIGS. 1-11.

The computing device 1210 includes the one or more processors 120. The one or more processors 120 are configured to communicate with system memory 1230, one or more storage devices 1240, one or more input/output interfaces 1250, one or more communications interfaces 1260, or any combination thereof. The system memory 1230 includes volatile memory devices (e.g., random access memory (RAM) devices), nonvolatile memory devices (e.g., read-only memory (ROM) devices, programmable read-only memory, and flash memory), or both. The system memory 1230 stores an operating system 1232, which may include a basic input/output system for booting the computing device 1210 as well as a full operating system to enable the computing device 1210 to interact with users, other programs, and other devices. The system memory 1230 stores system (program) data 1236, such as the flutter data 130, the modal strain energy data 132, the flutter strain energy distribution 134, the regions 136, the threshold 138, the model 140, the flutter characteristic 146, or a combination thereof. In a particular aspect, the system memory 1230 corresponds to the memory 108 of FIG. 1.

The system memory 1230 includes one or more applications 1234 (e.g., sets of instructions) executable by the one or more processors 120. As an example, the one or more applications 1234 include instructions executable by the one or more processors 120 to initiate, control, or perform one or more operations described with reference to FIGS. 1-11. To illustrate, the one or more applications 1234 include instructions executable by the one or more processors 120 to initiate, control, or perform one or more operations described with reference to the flutter strain energy unit 122, the region identifier 124, the model updater 126, or a combination thereof.

In a particular implementation, the system memory 1230 includes a non-transitory, computer readable medium storing the instructions that, when executed by the one or more processors 120, cause the one or more processors 120 to initiate, perform, or control operations to perform aeroelastic adjustment based on flutter vector strain energy. The operations include determining, based on flutter data and modal strain energy data, a flutter strain energy distribution of a modeled structure; identifying, based on the flutter strain energy distribution, regions of the modeled structure that are determined to have a flutter vector strain energy above a threshold; updating a model to increase a mass, a stiffness, or both, of one or more of the regions to improve a flutter characteristic of the modeled structure; and providing indicia including instructions for manufacture or modification of the modeled structure to achieve the improved flutter characteristic.

The one or more storage devices 1240 include nonvolatile storage devices, such as magnetic disks, optical disks, or flash memory devices. In a particular example, the storage devices 1240 include both removable and non-removable memory devices. The storage devices 1240 are configured to store an operating system, images of operating systems, applications (e.g., one or more of the applications 1234), and program data (e.g., the program data 1236). In a particular aspect, the system memory 1230, the storage devices 1240, or both, include tangible computer-readable media. In a particular aspect, one or more of the storage devices 1240 are external to the computing device 1210.

The one or more input/output interfaces 1250 enable the computing device 1210 to communicate with one or more input/output devices 1270 to facilitate user interaction. For example, the one or more input/output interfaces 1250 can include a display interface, an input interface, or both. For example, the input/output interface 1250 is adapted to receive input from a user, to receive input from another computing device, or a combination thereof. In some implementations, the input/output interface 1250 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 1270 includes one or more user interface devices and displays, including some combination of buttons, keyboards, pointing devices, displays, speakers, microphones, touch screens, and other devices. In a particular example, the input/output device 1270 include a display configured to display the instructions 152 to an operator of the device 102 of FIG. 1.

The one or more processors 120 are configured to communicate with one or more devices 1280 via the one or more communications interfaces 1260. For example, the one or more communications interfaces 1260 can include a network interface. The one or more devices 1280 can include, for example, one or more transmitters, one or more receivers, one or more other devices, or any combination thereof.

In conjunction with the described systems and methods, an apparatus for performing aeroelastic adjustment based on flutter data is disclosed that includes means for determining, based on flutter data and modal strain energy data, a flutter strain energy distribution of a modeled structure. In some implementations, the means for determining a flutter strain energy distribution of a modeled structure corresponds to the one or more processors 120, the flutter strain energy unit 122, the device 102, the computing device 1210, one or more other circuits or devices configured to determine, based on flutter data and modal strain energy data, a flutter strain energy distribution of a modeled structure, or a combination thereof.

The apparatus also includes means for identifying, based on the flutter strain energy distribution, regions of the modeled structure that are determined to have a flutter vector strain energy above a threshold. In some implementations, the means for identifying regions of the modeled structure that are determined to have a flutter vector strain energy above a threshold corresponds to the one or more processors 120, the region identifier 124, the device 102, the computing device 1210, one or more other circuits or devices configured to identify, based on the flutter strain energy distribution, regions of the modeled structure that are determined to have a flutter vector strain energy above a threshold, or a combination thereof.

The apparatus further includes means for updating a model to increase a mass, a stiffness, or both, of one or more of the regions to improve a flutter characteristic of the modeled structure. In some implementations, the means for updating a model corresponds to the one or more processors 120, the model updater 126, the device 102, the computing device 1210, one or more other circuits or devices configured to update a model to increase a mass, a stiffness, or both, of one or more of the regions to improve a flutter characteristic of the modeled structure, or a combination thereof.

The apparatus also includes means for providing indicia including instructions for manufacture or modification of the modeled structure to achieve the improved flutter characteristic. In some implementations, the means for providing indicia corresponds to the one or more processors 120, the device 102, the computing device 1210, the input/output interface 1250, the one or more input/output devices 1270, the communications interfaces 1260, the one or more devices 1280, one or more other circuits or devices configured to providing indicia including instructions for manufacture or modification of the modeled structure to achieve the improved flutter characteristic, or a combination thereof.

In some implementations, a non-transitory, computer readable medium stores instructions that, when executed by one or more processors, cause the one or more processors to initiate, perform, or control operations to perform part or all of the functionality described above. For example, the instructions may be executable to implement one or more of the operations or methods of FIGS. 1-12. In some implementations, part or all of one or more of the operations or methods of FIGS. 1-12 may be implemented by one or more processors (e.g., one or more central processing units (CPUs), one or more graphics processing units (GPUs), one or more neural processing units (NPUs), one or more digital signal processors (DSPs)) executing instructions, by dedicated hardware circuitry, or any combination thereof.

Particular aspects of the disclosure are described below in sets of interrelated Examples:

According to Example 1, a method includes: determining, based on flutter data and modal strain energy data, a flutter strain energy distribution of a modeled structure; identifying, based on the flutter strain energy distribution, regions of the modeled structure that are determined to have a flutter vector strain energy above a threshold; updating a model to increase a mass, a stiffness, or both, of one or more of the regions to improve a flutter characteristic of the modeled structure; and providing indicia including instructions for manufacture or modification of the modeled structure to achieve the improved flutter characteristic.

Example 2 includes the method of Example 1, wherein updating the model includes increasing the mass, the stiffness, or both, at a leading edge portion of the modeled structure, a trailing edge portion of the modeled structure, or both.

Example 3 includes the method of Example 1 or Example 2, wherein the modeled structure corresponds to a cantilevered structure having a root portion, a tip portion, a leading edge portion, and a trailing edge portion, and wherein updating the model includes increasing the mass, the stiffness, or both at a location that is between the root portion and the tip portion.

Example 4 includes the method of any of Example 1 to Example 3, wherein the modeled structure includes at least one flight surface of an aircraft.

Example 5 includes the method of Example 4, wherein the modeled structure corresponds to at least a portion of: a wing, a horizontal stabilizer, or a vertical stabilizer.

Example 6 includes the method of any of Example 1 to Example 5, wherein the flutter data indicates displacement in the modeled structure based on an aerodynamic model.

Example 7 includes the method of any of Example 1 to Example 6, wherein the modal strain energy data indicates strain energy in the modeled structure for one or more bending modes, one or more torsion modes, or a combination thereof.

Example 8 includes the method of any of Example 1 to Example 7, wherein the flutter strain energy distribution includes a mapping of flutter strain energy values to points of the modeled structure.

Example 9 includes the method of any of Example 1 to Example 8, wherein the modal strain energy data is determined based on a finite element model and the flutter data is determined based on an aerodynamic model.

Example 10 includes the method of any of Example 1 to Example 9, wherein the flutter characteristic corresponds to a flutter speed, and wherein increasing the mass, the stiffness, or both increases the flutter speed.

Example 11 includes the method of any of Example 1 to Example 10, wherein, after updating the model, the flutter vector strain energy of the one or more of the regions is below the threshold.

According to Example 12, a device includes: a memory configured to store instructions; and a processor configured to execute the instructions to perform the method of any of Example 1 to 11.

According to Example 13, a non-transitory computer-readable medium stores instructions that, when executed by a processor, cause the processor to perform the method of any of Example 1 to Example 11.

According to Example 14, an apparatus includes means for carrying out the method of any of Example 1 to Example 11.

According to Example 15, a non-transitory storage medium includes instructions that, when executed by one or more processors, cause the one or more processors to: determine, based on flutter data and modal strain energy data, a flutter strain energy distribution of a modeled structure; identify, based on the flutter strain energy distribution, regions of the modeled structure that are determined to have a flutter vector strain energy above a threshold; update a model to increase a mass, a stiffness, or both, of one or more of the regions to improve a flutter characteristic of the modeled structure; and provide indicia including instructions for manufacture or modification of the modeled structure to achieve the improved flutter characteristic.

Example 16 includes the non-transitory storage medium of Example 15, wherein the flutter data indicates displacement in the modeled structure based on an aerodynamic model.

Example 17 includes the non-transitory storage medium of Example 15 or Example 16, wherein the modal strain energy data indicates strain energy in the modeled structure for one or more bending modes, one or more torsion modes, or a combination thereof.

Example 18 includes the non-transitory storage medium of any of Example 15 to Example 17, wherein the flutter strain energy distribution includes a mapping of flutter strain energy values to points of the modeled structure.

Example 19 includes the non-transitory storage medium of any of Example 15 to Example 18, wherein the flutter characteristic corresponds to a flutter speed, and wherein increasing the mass, the stiffness, or both increases the flutter speed.

Example 20 includes the non-transitory storage medium of any of Example 15 to Example 19, wherein, after updating the model, the flutter vector strain energy of the one or more of the regions is below the threshold.

According to Example 21, an aircraft includes: a cantilevered structure having a root portion, a tip portion, a leading edge portion, and a trailing edge portion; and at least one flight surface that includes a surface of the cantilevered structure, wherein a region of the cantilevered structure that is located at substantially a midpoint between the root portion and the tip portion has an increased mass as compared to one or more neighboring regions of the cantilevered structure, and wherein the region is selected to have the increased mass to increase a flutter speed based on a flutter strain energy distribution generated from a model of the cantilevered structure.

Example 22 includes the aircraft of Example 21, wherein the cantilevered structure corresponds to at least a portion of: a wing, a horizontal stabilizer, or a vertical stabilizer.

Example 23 includes the aircraft of Example 21 or Example 22, wherein the region is further located at the leading edge portion of the cantilevered structure or the trailing edge portion of the cantilevered structure.

According to Example 24, a device includes: one or more processors configured to: determine, based on flutter data and modal strain energy data, a flutter strain energy distribution of a modeled structure; identify, based on the flutter strain energy distribution, regions of the modeled structure that are determined to have a flutter vector strain energy above a threshold; update a model to increase a mass, a stiffness, or both, of one or more of the regions to improve a flutter characteristic of the modeled structure; and provide indicia including instructions for manufacture or modification of the modeled structure to achieve the improved flutter characteristic.

Example 25 includes the device of Example 24, wherein the flutter data indicates displacement in the modeled structure based on an aerodynamic model.

Example 26 includes the device of Example 24 or Example 25, wherein the modal strain energy data indicates strain energy in the modeled structure for one or more bending modes, one or more torsion modes, or a combination thereof.

Example 27 includes the device of any of Example 24 to Example 26, wherein the flutter strain energy distribution includes a mapping of flutter strain energy values to points of the modeled structure.

Example 28 includes the device of any of Example 24 to Example 27, wherein the flutter characteristic corresponds to a flutter speed, and wherein increasing the mass, the stiffness, or both increases the flutter speed.

Example 29 includes the device of any of Example 24 to Example 28, wherein, after updating the model, the flutter vector strain energy of the one or more of the regions is below the threshold.

According to Example 30, an apparatus includes: means for determining, based on flutter data and modal strain energy data, a flutter strain energy distribution of a modeled structure; means for identifying, based on the flutter strain energy distribution, regions of the modeled structure that are determined to have a flutter vector strain energy above a threshold; means for updating a model to increase a mass, a stiffness, or both, of one or more of the regions to improve a flutter characteristic of the modeled structure; and means for providing indicia including instructions for manufacture or modification of the modeled structure to achieve the improved flutter characteristic.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single implementation for the purpose of streamlining the disclosure. Examples described above illustrate but do not limit the disclosure. It should also be understood that numerous modifications and variations are possible in accordance with the principles of the present disclosure. As the following claims reflect, the claimed subject matter may be directed to less than all of the features of any of the disclosed examples. Accordingly, the scope of the disclosure is defined by the following claims and their equivalents.

What is claimed is:

1. A method comprising:
determining, based on flutter data and modal strain energy data, a flutter strain energy distribution of a modeled structure;
identifying, based on the flutter strain energy distribution, regions of the modeled structure that are determined to have a flutter vector strain energy above a threshold;
updating a model to increase a mass, a stiffness, or both, of one or more of the regions to improve a flutter characteristic of the modeled structure; and
providing indicia including instructions for manufacture or modification of the modeled structure to achieve the improved flutter characteristic.

2. The method of claim 1, wherein updating the model includes increasing the mass, the stiffness, or both, at a leading edge portion of the modeled structure, a trailing edge portion of the modeled structure, or both.

3. The method of claim 1, wherein the modeled structure corresponds to a cantilevered structure having a root portion, a tip portion, a leading edge portion, and a trailing edge portion, and wherein updating the model includes increasing the mass, the stiffness, or both at a location that is between the root portion and the tip portion.

4. The method of claim 1, wherein the modeled structure includes at least one flight surface of an aircraft.

5. The method of claim 4, wherein the modeled structure corresponds to at least a portion of: a wing, a horizontal stabilizer, or a vertical stabilizer.

6. The method of claim 1, wherein the flutter data indicates displacement in the modeled structure based on an aerodynamic model.

7. The method of claim 1, wherein the modal strain energy data indicates strain energy in the modeled structure for one or more bending modes, one or more torsion modes, or a combination thereof.

8. The method of claim 1, wherein the flutter strain energy distribution includes a mapping of flutter strain energy values to points of the modeled structure.

9. The method of claim 1, wherein the modal strain energy data is determined based on a finite element model and the flutter data is determined based on an aerodynamic model.

10. The method of claim 1, wherein the flutter characteristic corresponds to a flutter speed, and wherein increasing the mass, the stiffness, or both increases the flutter speed.

11. The method of claim 1, wherein, after updating the model, the flutter vector strain energy of the one or more of the regions is below the threshold.

12. A non-transitory storage medium comprising instructions that, when executed by one or more processors, cause the one or more processors to:
determine, based on flutter data and modal strain energy data, a flutter strain energy distribution of a modeled structure;
identify, based on the flutter strain energy distribution, regions of the modeled structure that are determined to have a flutter vector strain energy above a threshold;
update a model to increase a mass, a stiffness, or both, of one or more of the regions to improve a flutter characteristic of the modeled structure; and
provide indicia including instructions for manufacture or modification of the modeled structure to achieve the improved flutter characteristic.

13. The non-transitory storage medium of claim 12, wherein the flutter data indicates displacement in the modeled structure based on an aerodynamic model.

14. The non-transitory storage medium of claim 12, wherein the modal strain energy data indicates strain energy in the modeled structure for one or more bending modes, one or more torsion modes, or a combination thereof.

15. The non-transitory storage medium of claim 12, wherein the flutter strain energy distribution includes a mapping of flutter strain energy values to points of the modeled structure.

16. The non-transitory storage medium of claim 12, wherein the flutter characteristic corresponds to a flutter speed, and wherein increasing the mass, the stiffness, or both increases the flutter speed.

17. The non-transitory storage medium of claim 12, wherein, after updating the model, the flutter vector strain energy of the one or more of the regions is below the threshold.

18. An aircraft comprising:
a cantilevered structure having a root portion, a tip portion, a leading edge portion, and a trailing edge portion; and
at least one flight surface that includes a surface of the cantilevered structure,
wherein a region of the cantilevered structure that is located at substantially a midpoint between the root portion and the tip portion has an increased mass as compared to one or more neighboring regions of the cantilevered structure, and
wherein the region is selected to have the increased mass to increase a flutter speed based on a flutter strain energy distribution generated from a model of the cantilevered structure.

19. The aircraft of claim 18, wherein the cantilevered structure corresponds to at least a portion of: a wing, a horizontal stabilizer, or a vertical stabilizer.

20. The aircraft of claim 18, wherein the region is further located at the leading edge portion of the cantilevered structure or the trailing edge portion of the cantilevered structure.
